(19) United States
(12) Patent Application Publication
(10) Pub. No.: US 2023/0229168 A1
(43) Pub. Date: Jul. 20, 2023

(54) METHOD FOR BYPASSING IMPASSABLE OBJECTS BY A ROBOT

(71) Applicant: BSH Hausgeräte GmbH, München (DE)

(72) Inventors: Sandeep Bairampalli, Bangalore (IN); Maximilian Fremerey, Saal an der Saale (DE); Pratip Ghosh, Bangalore (IN); Ganesh Nithin, Bangalore (IN)

(21) Appl. No.: 17/928,948

(22) PCT Filed: May 20, 2021
(86) PCT No.: PCT/EP2021/063496

§ 371 Date: Dec. 1, 2022

(30) Foreign Application Priority Data
Jun. 2, 2020 (DE) 10 2020 206 871.2

(51) Int. Cl. G05D 1/02; G05D 1/00; G05B 13/02

(52) U.S. Cl. CPC G05D 1/0214; G05D 1/0231; G05D 1/0088; G05B 13/027; G05D 2201/0203

(57) ABSTRACT

A method for bypassing impassable objects by a robot through the use of artificial intelligence. A reliable and low-cost bypassing of obstacles taking account of data privacy aspects is achieved in that in the event of a collision of the robot with an obstacle, an optical original recording of the obstacle is produced, artificial duplicates being generated from the original recording, the duplicates being used to train the artificial intelligence. A system has a robot and an IT infrastructure configured to execute the method.

The present invention relates to a method for the bypassing of impassable obstacles by a robot, in particular household robot, through the use of artificial intelligence. The invention also relates to a system which comprises a robot and an IT infrastructure and which is embodied to carry out the method. The invention further relates to a corresponding computer program and a corresponding computer-readable medium.

A robot, in particular a household robot, moves through a room during operation. A household robot moves for example through predetermined rooms in a household. For this purpose, a routine for movement, also referred to in the following as the movement routine, is typically provided for the robot and is executed taking account of the robot's surroundings. Important aspects of such routines are the detection and bypassing of obstacles which are impassable for the robot.

Methods are known from the prior art which realize and/or improve the routines of household robots through the use of artificial intelligence.

For example, a cleaning robot is known from DE 10 2016 124 916 A1 as a household robot which uses an optical recording facility to produce images of obstacles which are described manually by a user. The description associated with the respective image is used by an artificial intelligence to implement the detection of the respective obstacle in the movement routine such that the obstacle is bypassed. It is disadvantageous here that the respective image needs to be described manually by the user.

A household robot having a sensor facility for detecting obstacles is known from US 2018/0 210 445 A1. Upon detection of the obstacle, an image of the obstacle is produced and stored in a map of the room through which the household robot moves, which map is provided for the movement routine. An artificial intelligence is used to detect characteristics of the obstacle. The knowledge gained by the artificial intelligence about the characteristics of the obstacle is subsequently used in the movement routine of the robot. It is disadvantageous here that if an obstacle is displaced in the room, this obstacle is not detected or is detected less reliably.

It is therefore generally known from the prior art to take account of obstacles in the movement routine such that these are bypassed. Because the number and frequency of potential obstacles differs from room to room and can change both in terms of time and with regard to position, it is desirable to detect and bypass new or unknown obstacles in a reliable manner in the movement routine.

One aspect in the use of artificial intelligence and the associated improvements to the movement routine is what is known as machine learning. What is known as training data is required for this purpose, with which the artificial intelligence is trained in order to improve the movement routine. During a movement routine which optically records the surroundings of the robot, a multiplicity of optical recordings is thus required for machine learning. On account of the described multiplicity of possible obstacles and their variations in terms of position, a very large quantity of optical recordings is thus required in order to optimize the artificial intelligence accordingly. It is problematic here that such a large quantity of recordings is not available and/or that the procurement of such recordings is cost-intensive. Furthermore, taking account of data privacy principles leads to the required recordings not being able to be produced and used in an arbitrary manner.

The present invention therefore addresses the object of specifying improved or at least other embodiments for a method for the bypassing of obstacles by a robot and for an associated system, which embodiments are characterized in particular by a bypassing of obstacles which is cost-efficient and/or effective and/or complies with data privacy law.

This object is achieved according to the invention by the subject matter of the independent claims. Advantageous embodiments are the subject matter of the dependent claims.

The present invention is based on the general concept of the bypassing of impassable obstacles by a robot by detecting the respective obstacle by way of a collision of the robot with the obstacle, producing an optical recording of the obstacle, and from the optical recording artificially generating a multiplicity of duplicates which differ from one another and are used to train an artificial intelligence, wherein the training result is subsequently used such that the robot bypasses the obstacle in future. This relates in particular to obstacles which are unknown to a movement routine used during the movement of the robot at the time of the collision. The solution according to the invention thus makes it possible, by producing an optical recording of the in particular unknown or new obstacle, also referred to in the following as the original recording, to train the artificial intelligence by a multiplicity of duplicates being generated artificially from the original recording. It is thus in particular also possible for obstacles which are unknown prior to the collision to be taken into account in the movement routine such that they are bypassed, thereby preventing a collision with the obstacles. At the same time, a reduced number of original recordings, in particular only a single original recording of the respective obstacle, is required in order to train the artificial intelligence. In this way, training the artificial intelligence and improving the movement routine on the basis of a reduced number of original recordings, in particular a single original recording of the obstacle, can be implemented in a cost-efficient and reliable manner, also taking account of data privacy requirements. Furthermore, the idea according to the invention results in specific obstacles being reliably bypassed also for the respective surroundings, in particular for the respective room, through which the robot moves, in particular also if the position of said obstacles in the room changes.

In accordance with the inventive concept, in a method for the bypassing of impassable obstacles by a robot, a collision of the robot with an obstacle is detected as the robot moves through a room. Upon detection of the collision, an optical original recording, in particular a photograph, of the obstacle is produced. A multiplicity of duplicates is subsequently generated artificially from the original recording, wherein the duplicates in each case take account of the geometry of the obstacle and differ from one another. The duplicates are subsequently used in a training process at least partially to train an artificial intelligence, in particular a neural network. This means that the artificial intelligence, in particular the neural network, is trained with at least some of the duplicates, such that the robot detects the obstacle prior to a collision with the obstacle. A result of this training process, also referred to in the following as the training result, is then used for the bypassing of the obstacle by the robot.

The method according to the invention is therefore triggered by the collision of the robot with an obstacle, wherein the collision serves simultaneously to identify the obstacle as an impassable obstacle or at least as an indicator thereof.

The use of the training result for bypassing the obstacle expediently takes place by taking account of and/or integrating the training result in the movement routine.

The method according to the invention is in particular a computer-implemented method. The method can therefore be carried out in particular by way of data processing means.

The robot can in principle be any robot which moves through the room during operation.

The robot is in particular a household robot which moves through a household during operation. Here, the robot can be used for cleaning purposes. The robot can therefore be for example a cleaning robot, for example a robot vacuum cleaner.

In preferred embodiments, the original recording also serves to generate duplicates, which are used for training. This means that a multiplicity of duplicates is generated from the original recording, which duplicates take account of the geometry of the obstacle and in each case differ from one other, wherein these duplicates are used in the training process. These duplicates are also referred to in the following as training duplicates. In addition, a multiplicity of duplicates is generated from the original recording, which duplicates take account of the geometry of the obstacle and in each case differ from one other, wherein these duplicates are used to test the training process. These duplicates are also referred to in the following as test duplicates. The artificial intelligence, in particular the neural network, is trained in the training process with the training duplicates. Here, the training process is broken down into intervals and an intermediate result of the training process is tested in a test process with at least some of the test duplicates. In the respective test process, the intermediate result is tested in order to determine how likely the robot is to detect the obstacle prior to a collision. If the likelihood lies above a predetermined value, the intermediate result is defined as the training result and used. If, on the other hand, the likelihood lies below the predetermined value, the training process is continued and testing is subsequently performed at intervals by means of test processes. In this way, based on the original recording of the obstacle, in particular a single original recording, both the training of the artificial intelligence and the testing of the artificial intelligence, in particular of the training result, are realized.

During generation of the artificial duplicates, the geometry of the obstacle stemming from the original recording is taken into account in each case. This means in particular that the geometry of the obstacle is retained in at least some of the duplicates.

Alternatively or in addition, it is possible to change the geometry of the obstacle slightly in at least some of the duplicates. The slight change is possible in particular if the artificial intelligence can assign the obstacle to a known object, wherein individual properties of the object can be changed. Reference is made here by way of example to a door as the obstacle. Insofar as the obstacle is identified as a door, it is possible for example to change the shape and/or size of a handle of the door in order to generate different duplicates. The relative arrangement of the handle can likewise be changed in order to generate different duplicates.

At least some of the duplicates are advantageously generated as a result of surroundings, in particular a background, of the obstacle differing from one duplicate to another. This means that variations are introduced artificially into the surroundings, in particular the background, of the obstacle in order to generate different duplicates.

Alternatively or in addition, it is conceivable that at least some of the duplicates are generated such that a position of the obstacle differs from one duplicate to another. This means that a position of the obstacle is changed artificially in order to generate different duplicates. The different positions relate for example to linear displacements and/or rotations of the obstacle. Reference is made here once again by way of example to a door, the closing position of which is varied artificially in order to generate different duplicates.

It is likewise conceivable, alternatively or in addition, to change the color of the object artificially in order to generate different duplicates.

It is preferred if the original recording is produced at a distance from the object. This means that the original recording does not show a close-up view of the object. This enables an improved generation of duplicates and leads to a more reliable bypassing of the obstacle.

It is understood that, in addition to the specified method, the scope of this invention also includes a system in which the method is carried out.

The system comprises the robot as well as an IT infrastructure.

The robot advantageously has an optical recording facility for producing optical recordings as well as a movement facility for the automatic movement of the robot. The optical recording facility is preferably also used to carry out the movement routine, in other words in particular to navigate the robot through a room. The original recording is thus produced by the robot, preferably using the optical recording facility which is also used to carry out the movement routine. This results in a simplified design of the robot and thus to a cost-efficient manufacture. The artificial intelligence is realized in the IT infrastructure. The IT infrastructure therefore comprises the artificial intelligence, in particular the neural network. Here, the system is embodied such that it carries out the method according to the invention.

The system is embodied in particular such that the robot produces the original recording with the recording facility and transmits it to the IT infrastructure. The system is further embodied such that the IT infrastructure generates the duplicates and carries out the training process as well as if necessary the respective test process.

The IT infrastructure can in principle be entirely separate from the robot.

Variants are advantageous in which the robot has a control facility which is a component of the IT infrastructure. It is advantageous here if the control facility serves in particular to carry out the movement routine. The IT infrastructure also has a main structure, separate from the robot, which comprises the artificial intelligence, in particular the neural network. The resource-intensive processes of the IT infrastructure are thus carried out outside of the robot. As a result, the robot can be manufactured simply and cost-efficiently. In addition, the main structure can be used for a multiplicity of robots so that the entire system is embodied more simply and cost-efficiently. The system expediently comprises a communication facility via which the robot, in particular the control facility, and the main structure communicate with one another. The communication facility is embodied in particular for wireless communication between the robot and the main structure.

Here, the robot produces the original recording, in particular with the recording facility and the control facility. In order to produce the original recording following the collision with the obstacle, the robot can be moved away from the obstacle during this process so as to produce the original recording at a distance from the obstacle. The original recording is transmitted via the communication facility to the main structure. If a training result is available, this is preferably transmitted via the communication facility to the robot, which takes account of this training result in order to bypass the obstacle in future.

The main structure can in principle be assigned locally to a user. The main structure can therefore be in particular a local server, in particular a home server.

The main structure is preferably realized as a cloud service. This enables a realization of the system which is versatile to use and cost-efficient overall.

The movement facility serves to move the robot automatically through a room. For this purpose, the movement facility has for example an electric motor and the like.

The robot advantageously has a facility for detecting collisions of the robot with obstacles, which is also referred to below as the detection facility. The detection of the collision therefore takes place within the robot, so that a continuous use of the artificial intelligence in the manner described according to the invention, in other words for generating the duplicates and for training, is not necessary. In addition, the method according to the invention is triggered in this way by the robot.

The detection facility can in principle be embodied in any manner, provided that it enables a collision of the robot with an obstacle to be detected.

The detection facility can have for example at least one tactile sensor which detects a collision with an obstacle by way of a tactile contact with the obstacle. Alternatively or in addition, the detection facility can monitor a power consumption of the movement facility, for example of the electric motor, in order to detect a collision on the basis of the power consumption. In particular, a sudden and sharp increase in power consumption is used here as an indicator for a collision. It is conceivable, alternatively or in addition, to detect the collision with an obstacle through the combined use of several sensors. In particular, power consumption information of the detection facility can for example be advantageously combined with data of an inertial sensor system, which advantageously has a gyroscope and/or an acceleration sensor, in order to distinguish more reliably between collisions and other states with increased power consumption, such as movements across carpets and other soft substrates.

Depending on the envisaged use, the robot can of course also have further components. For example, a cleaning robot can have a cleaning facility, such as a suction facility for vacuum cleaning a substrate.

It is understood that, in addition to the method and the system, the scope of this invention also includes a computer program comprising commands which cause the method according to the invention to be carried out, in particular cause the system to carry out the method according to the invention. The scope of this invention likewise includes a computer-readable medium on which such a computer program is stored.

Further key features and advantages of the invention will become apparent from the dependent claims, the drawings, and the associated description of the figures with reference to the drawings.

It is understood that the features mentioned above and yet to be explained below are usable not only in the combination specified in each case but also in other combinations or alone without departing from the scope of the present invention.

Preferred exemplary embodiments of the invention are shown in the drawings and are explained in more detail in the following description, wherein the same reference characters relate to the same or similar or functionally identical components.

In the drawings, in each case in schematic form,

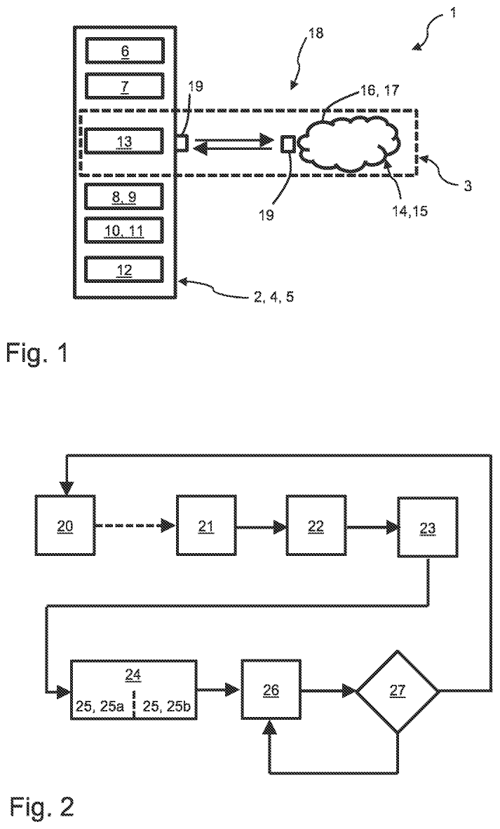

FIG. 1 shows a highly simplified, symbolic representation of a system with a robot and an IT infrastructure,

FIG. 2 shows a flowchart of a method for operating the system.

A system 1, as is shown by way of example in highly simplified form in FIG. 1, is operated in accordance with a method which is shown by way of example in FIG. 2 on the basis of a flowchart.

The system 1 comprises a robot 2 as well as an IT infrastructure 3. In the exemplary embodiment shown, the robot 2 is a household robot 4, for example a cleaning robot 5 for cleaning a household (not shown). The robot 2 has an optical recording facility 6, which is preferably used for moving and navigating the robot 2. With the optical recording facility 6, it is possible in particular to produce optical recordings of the surroundings of the robot 2. The robot 2 also has a movement facility 7 for automatically moving the robot 2. The movement facility 7 can have for example an electric motor (not shown), which drives at least one wheel (not shown) of the robot 2. To supply energy to the robot 2, the robot also has an energy storage unit 8, in particular a rechargeable battery 9. The robot 2 embodied as a cleaning robot 5 also has a cleaning facility 10, for example a suction facility 11, with which the robot 2 cleans a room (not shown), in particular the household. The robot 2 also has a detection facility 12, which is embodied such that it detects a collision of the robot 2 with an obstacle (not shown).

The IT infrastructure 3 comprises components arranged in the robot 2 as well as components separate from the robot 2, and is indicated in FIG. 1 by a dashed box. A control facility 13 of the robot 2 is a component of the IT infrastructure 3. The control facility 13 is connected in a communicative manner to the recording facility 6 and the movement facility 7. The control facility is preferably also connected in a communicative manner to the detection facility 12. A routine 20 (see FIG. 2) for moving the robot 2, also referred to in the following as the movement routine 20, is stored in the control facility 13. For example, a room through which the robot 2 is required or permitted to move is mapped in the movement routine 20. The movement routine 20 can also contain obstacles which are to be bypassed by the robot 2, wherein these obstacles are also referred to in the following as known obstacles.

The IT infrastructure 3 further comprises a main structure 14, which in the example shown and preferably is a cloud service 15. The main structure 14 comprises an artificial intelligence 16, in particular a neural network 17. The robot 2, in particular the control facility 13, and the main structure 14 communicate with one another via a communication facility 18, preferably wirelessly, wherein the communication facility 18 on the robot 2 and on the main structure 14 in each case has a communication unit 19.

In accordance with the flowchart shown by way of example in FIG. 2, the robot 2 is moved through the room using the movement routine 20. Here, the surroundings are monitored with the recording facility 6. When known obstacles are detected, they are bypassed, in other words a collision of the robot 2 with the known obstacle is prevented. The recording facility 6 is thus used to navigate the robot 2. During operation, a cleaning of the room, in particular of a substrate (not shown), takes place by way of the robot 2 embodied as a cleaning robot 5 with the aid of the cleaning facility 10.

A method for bypassing obstacles which are not taken into account in the movement routine 20, also referred to in the following as unknown obstacles, is triggered when the robot 2 collides with such an obstacle. For this reason, the transition to a subsequent measure 21 is shown dashed in FIG. 2. Here, during this measure 21 which triggers the method, also referred to in the following as the detection measure 21, a collision of the robot 2 with the obstacle is detected. The detection facility 12 of the robot 2 is used for this purpose. The collision which has taken place with the obstacle serves as a reason to assume that an unknown obstacle is involved. During a subsequent measure 22, the robot 2 is moved away from the obstacle so that the robot 2 is arranged at a distance from the obstacle. This measure 22 is therefore also referred to in the following as the distance measure 22. With the robot 2 located at a distance from the obstacle, an optical recording of the obstacle is produced with the aid of the recording facility 6 during a measure 23 which is also referred to in the following as the recording measure 23, wherein this recording is also referred to in the following as the original recording. The original recording is then transmitted with the aid of the communication facility 18 to the main structure 14.

The method is continued in the main structure 14. In the main structure 14, during a duplication measure 24, a multiplicity of duplicates 25 of the original recording is generated artificially. The duplicates 25 in each case take account of the geometry of the obstacle and differ from one another. The differences in the duplicates 25 can be realized by artificially generated, different positions of the obstacle and/or artificially generated, different colors of the obstacle and/or artificially generated, different backgrounds of the obstacle. The duplicates 25 are divided into two groups, namely into training duplicates 25a and test duplicates 25b.

The artificial intelligence 16 is subsequently trained with the training duplicates 25a in a training process 26. In the training process 26, the artificial intelligence 16, in particular the neural network 17, is trained such that the robot 2 detects the obstacle prior to a collision and bypasses it in the movement routine 20. In a test process 27, the training process 26 is broken down into intervals and thus paused. During the test process 27, a result of the training process 26 achieved to date, also referred to in the following as the intermediate result, is tested. Here, the test duplicates 25b are used during the test process 27. In the test process 26, testing is carried out with at least some of the test duplicates 25b to determine how likely the robot 2, in particular the movement routine 20 using the intermediate result, is to detect the obstacle prior to a collision. If the likelihood lies below a predetermined value, the method returns to the training process 26 and the training process 26 is continued. If the likelihood lies above the predetermined value, the intermediate result is captured as the training result and used during the movement routine 20 of the robot 2. For this purpose, the main structure 14 uses the communication facility 18 to transmit the training result to the control facility 13 in order to integrate the training result into the movement routine 20. The integration of the training result into the movement routine 20 can take place within the robot 2, in particular by way of the control facility 13. Alternatively, the main structure 14 can integrate the training result into the movement routine 20 and transmit the movement routine 20 which takes account of the training result in particular to the control facility 13, which then uses the movement routine 20 which takes account of the training result.

The robot 2 can be operated normally during the training process 26 and the test process 27. This means in particular that the robot 2 can use the available movement routine 20 during the training process 26 and the test process 27.

### LIST OF REFERENCE CHARACTERS

1 System
2 Robot
3 IT infrastructure
4 Household robot
5 Cleaning robot
6 Recording facility
7 Movement facility
8 Energy storage unit
9 Battery
10 Cleaning facility
11 Suction facility
12 Detection facility
13 Control facility
14 Main structure
15 Cloud service
16 Artificial intelligence
17 Neural network
18 Communication facility
19 Communication unit
20 Movement routine
21 Detection measure
22 Distance measure
23 Distance measure
24 Duplication measure
25 Duplicate
26 Training process
27 Test process

1-10. (canceled)

11. A method for a bypassing of impassable obstacles by a robot, which comprises the steps of:
detecting a collision of the robot with an obstacle as the robot moves through a room;
producing an optical original recording of the obstacle;
generating a plurality of artificial duplicates from the optical original recording, the artificial duplicates in each case take account of a geometry of the obstacle and differ from one another;
training an artificial intelligence using at least some of the artificial duplicates in a training process such that the robot detects the obstacle prior to the collision with the obstacle; and
using a training result of a training process for the bypassing of the obstacle by the robot.

12. The method according to claim 11, which further comprises:
generating training duplicates and test duplicates from the optical original recording;
training the artificial intelligence in the training process with the training duplicates;
breaking down the training process into intervals and an intermediate result of the training process is tested in a test process with at least some of the test duplicates in order to determine how likely the robot is to detect the obstacle prior to the collision; and
using the intermediate result as the training result if a likelihood lies above a predetermined value.

13. The method according to claim 11, which further comprises generating at least some of the artificial duplicates such that surroundings of the obstacle differ from one of the artificial duplicates to another.

14. The method according to claim 11, which further comprises generating at least some of the artificial duplicates such that a position of the obstacle differs from one of the artificial duplicates to another.

15. The method according to claim 11, which further comprises producing the optical original recording at a distance from the obstacle.

16. The method according to claim 11, wherein:
the method is a computer-implemented method;
the robot is a household robot; and
the artificial intelligence is a neural network.

17. A system, comprising:
a robot having an optical recording facility for producing optical recordings and a movement facility for moving said robot;
an information technology (IT) infrastructure having an artificial intelligence; and
the system being embodied to carry out the method as claimed in claim 11.

18. The system according to claim 17,
wherein said robot has a controller which is a component of said IT infrastructure;
wherein said IT infrastructure has a main structure, separate from said robot, which contains said artificial intelligence; and
further comprising a communication facility for communication between said controller and said main structure.

19. The system according to claim 17, wherein said robot has a detector for detecting collisions of said robot with obstacles.

20. The system according to claim 17, wherein:
said robot is a household robot; and
said artificial intelligence is a neural network.

21. A non-transitory computer program having computer-executable instructions which when executed by a system containing a robot having an optical recording facility for producing optical recordings and a movement facility for moving said robot and an information technology (IT) infrastructure having an artificial intelligence, the computer-executable instructions causing the system to:
detect a collision of the robot with an obstacle as the robot moves through a room;
produce an optical original recording of the obstacle;
generate a plurality of artificial duplicates from the optical original recording, the artificial duplicates in each case take account of a geometry of the obstacle and differ from one another;
train the artificial intelligence using at least some of the artificial duplicates in a training process such that the robot detects the obstacle prior to the collision with the obstacle; and
use a training result of the training process for bypassing of the obstacle by the robot.

22. A non-transitory computer-readable medium having computer-executable instructions for performing the method according to claim 11.
